(19) United States
(12) Patent Application Publication
(10) Pub. No.: US 2005/0083206 A1
(43) Pub. Date: Apr. 21, 2005

(54) Remote electrical power monitoring systems and methods

(76) Inventors: Philip R. Couch, Honiton (GB); Rob Harman, Troutville, VA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/934,770

(22) Filed: Sep. 3, 2004

Related U.S. Application Data
(60) Provisional application No. 60/500,243, filed on Sep. 5, 2003.

(51) Int. Cl. G08B 21/00

(52) U.S. Cl. 340/657

(57) ABSTRACT

An electrical monitoring device includes an attachment arrangement adapted to attach the device, non-invasively, to an electrical supply line; a current sensor adapted to sense waveform characteristics relating to current flowing through the supply line; a voltage sensor adapted to sense voltage waveform characteristics of the supply line; and a processor programmed to calculate a power component using the current waveform characteristics and voltage waveform characteristics. The device also includes a wireless transmitter configured to transmit the power component to a monitoring location.

### CROSS-REFERENCES TO RELATED APPLICATIONS

This application is a non-provisional of, and claims the benefit of, co-pending U.S. Provisional Application No. 60/500,243, entitled “REMOTE ELECTRICAL POWER MONITORING,” filed on Sep. 5, 2003, by Philip R. Couch, the entire disclosure of which is herein incorporated by reference for all purposes.

### BACKGROUND OF THE INVENTION

Embodiments of the present invention relate generally to electrical power monitoring. More specifically, embodiments of the invention relate to systems and methods for remotely monitoring electrical power.

A desirable objective in electrical power engineering is to monitor electrical power flowing in a branch cable without intrusive connection (i.e., without requiring cutting into and re-wiring the transmission cable). To measure power flowing in a cable, one needs to know the voltage, the current, and their AC phase relationship. AC current in a conductor can be measured with a non-contact inductive current probe or similar device. But the voltage component requires intrusive wire-tapping. To avoid tapping the wire at multiple points where the power is to be measured in a system, a single voltage tap may be made at the “root” of the system and used as a reference for several power measurements.

This approach works fine when the current sensors are close to the voltage sensor, i.e., close to the “root” of the subsystem, which may be at the breaker or distribution panel. But it would be desirable to distribute the power monitoring more freely in the system. Embodiments of the present invention address these and other problems.

### BRIEF SUMMARY OF THE INVENTION

Embodiments of the invention thus provide electrical monitoring device. The device includes an attachment arrangement adapted to attach the device, non-invasively, to an electrical supply line and a current sensor adapted to sense waveform characteristics relating to current flowing through the supply line. The device also includes a voltage sensor adapted to sense voltage waveform characteristics of the supply line and a processor programmed to calculate a power component using the current waveform characteristics and voltage waveform characteristics. The device also includes a wireless transmitter configured to transmit the power component to a monitoring location.

In some embodiments of the device, the transmitter may be a bidirectional transmitter configured to receive a mean absolute voltage measurement. The processor may be further programmed to calculate a power value using the power component and the mean absolute voltage measurement. The transmitter may be further configured to transmit the power value to a monitoring location. The device may be programmed to transmit information periodically and/or upon interrogation.

In some embodiments, an electrical power monitoring system includes a voltage monitoring arrangement, located proximate a distribution point, that is configured to measure mean absolute voltage in a supply of power delivered from the distribution point to a load. The system also includes a current sensing arrangement, positioned proximate the load, configured to measure current waveform characteristics in the supply. The system further includes a non-invasive voltage monitoring arrangement, positioned proximate the current sensing arrangement, configured to measure voltage waveform characteristics in the supply. The system includes a first processor programmed to calculate an un-scaled power component using the current waveform characteristics and voltage waveform characteristics and a transmitter configured to transmit the un-scaled power component to a power monitoring location. The system also includes a second processor at the power monitoring location programmed to calculate the power delivered to the load by combining the un-scaled power component with the mean absolute voltage measurement.

In some embodiments of the electrical power monitoring system, the transmitter may be a wireless transmitter. The voltage monitoring arrangement and the non-invasive voltage monitoring arrangement may be different devices.

In still other embodiments, an electrical power monitoring system includes a voltage monitoring arrangement, located proximate a distribution point, that is configured to measure voltage magnitude in a power supply delivered from the distribution point to a load. The system also includes a current sensing arrangement, positioned proximate the load, that is configured to measure current magnitude and current waveform in the power supply delivered to the load. The system further includes a non-invasive voltage monitoring arrangement, positioned proximate the current sensing arrangement, that is configured to measure voltage waveform in the power supply. A first processor is programmed to calculate an un-scaled power component using the current waveform, voltage waveform, and current magnitude measurements. A first transmitter is configured to transmit the voltage magnitude measurement to a power monitoring location. A second processor at the power monitoring location is programmed to calculate the power delivered to the load by combining the un-scaled power component with the voltage magnitude measurement.

In some embodiments of the electrical power monitoring system, the power monitoring location may be the location of the current sensing arrangement. The system may include a second transmitter configured to transmit the power delivered to the load to a different location. The second transmitter may be a wireless transmitter. The current sensing arrangement and the non-invasive voltage monitoring arrangement may be a single monitoring device. The monitoring device may include a power supply which may be a solar power supply, battery, and/or parasitic power supply.

In other embodiments, a method of measuring power delivered to a load from a power supply includes sensing voltage magnitude at a first location, sensing current magnitude, current waveform, and voltage waveform at a second location, calculating an un-scaled power component at the first location using the current magnitude, current waveform, and voltage waveform, transmitting either the voltage magnitude, the un-scaled power component, or both via a wireless transmission to a third location, and calculating the power delivered to the load at the third location.

In some embodiments of the method of measuring power delivered to the load, the third location and the first location may be the same location. In other embodiments, the third location and the second location may be the same location. Transmitting may be based on a predetermined schedule and/or upon interrogation. Sensing current magnitude, current waveform, and voltage waveform at a second location may include sensing current magnitude, current waveform, and voltage waveform using a non-invasive sensing device.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an electrical distribution system employing power monitoring according to embodiments of the present invention.

FIG. 2 illustrates a transmission line having attached thereto an exemplary current monitor and an exemplary voltage monitor according to embodiments of the invention.

FIG. 3 illustrates a method of remote power monitoring according to embodiments of the invention.

### DETAILED DESCRIPTION OF THE INVENTION

Embodiments of the invention relate to remote electrical power monitoring systems and methods. According to some embodiments, mean absolute voltage in an electrical distribution system is measured at a distribution panel, breaker, or other central location. A non-intrusive current sensor is attached to a distribution line feeding a load for which power monitoring is desired and is configured to measure the current magnitude and waveform characteristics. The load is located some distance from the central location. A non-intrusive voltage phase sensor (e.g., a capacitive tap) also is located at the remote load and measures the voltage waveform characteristics, with the exception of mean absolute voltage. The voltage waveform is combined with the current magnitude and waveform to produce a power component that need only be scaled using the mean absolute voltage measurement to produce the absolute power measurement that is desired. The un-scaled power component and the mean absolute voltage may be combined in any of a number of ways.

In a first example, the un-scaled power component and the mean absolute voltage component may be transmitted to a central monitoring location separately. Either or both transmissions may be via wired or wireless transmission means. In a second example, the mean absolute voltage component is sent to the current monitoring location via either wired or wireless transmission means. In a third example, the un-scaled power component may be sent to the mean absolute voltage monitoring location via wired or wireless transmission means.

In some embodiments, only the current components are monitored remotely. This information is then sent via either wired or wireless transmission to a location where the mean absolute voltage and voltage waveform information are available. Because the timing of the voltage phase relative to the current phase is critical to the power calculation, the measurements in this embodiment need to be time correlated. This may be done in a number of ways. In a first example, individual sample measurements are time stamped and correlated prior to calculating the power component. In another example, the individual sample measurements are transmitted only over distances which would not affect the final power value. Other examples are possible.

In some embodiments, the voltage waveform and current waveform are determined by sampling. The sampling frequency may be selected based on the frequency of the component being measured. For example, if the voltage frequency is 60 Hz, then, using a sample frequency of 61 Hz, a complete voltage cycle may be reproduced from a sampling of 60 consecutive cycles. A similar process may be used to measure a current cycle. The reconstructed waveforms may be used to locate the voltage waveform relative to the current waveform.

Measurement devices described herein may be unidirectional or bidirectional. Further, the devices may be solar powered. Voltage monitoring devices may be configured to broadcast measurements to a number of current/voltage phase measurement devices.

Embodiments of the invention may be deployed in a number of useful applications, including machinery in a factory, motors powering oil-well pumps, monitoring points in national electrical grids, and the like. Monitoring, according to some embodiments, on a finer scale than present day metering allows optimization of the electrical distribution in the grid, and the generation of electrical cost information for specific machines to evaluate their efficiency, cost effectiveness, etc.

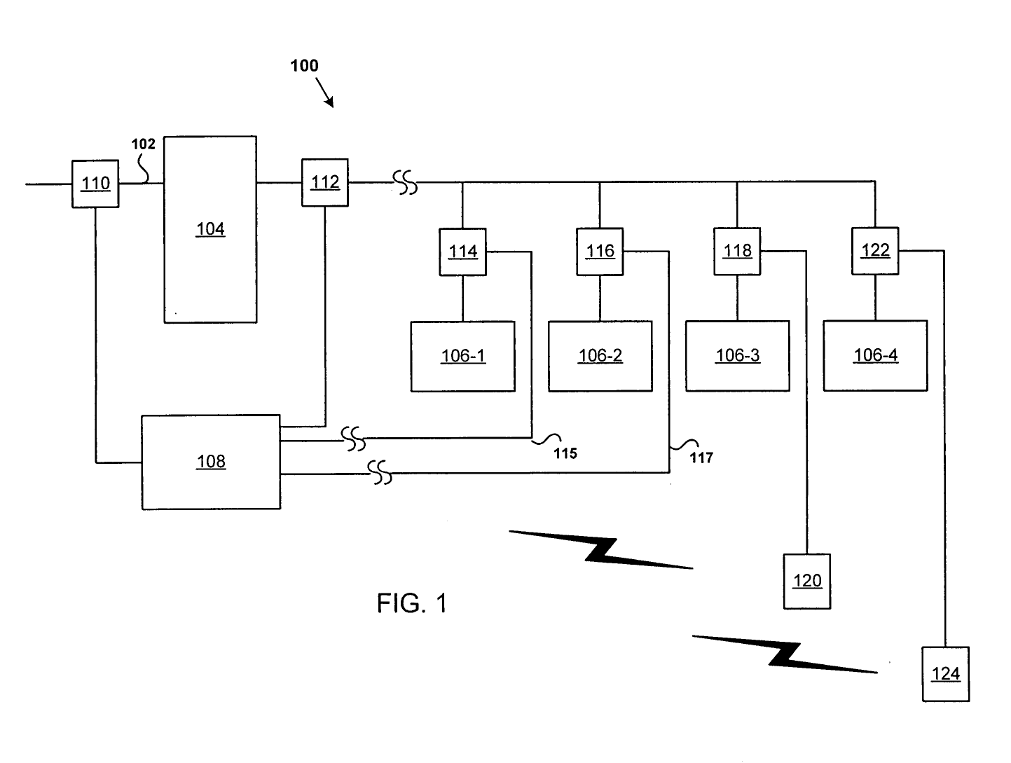

Having described embodiments of the present invention generally, attention is directed to FIG. 1, which illustrates an exemplary electrical distribution system 100 employing monitoring according to embodiments of the invention. The system 100 of FIG. 1 includes an electrical power supply 102 and a distribution panel 104 that distributes the electrical power to four loads 106. The loads are located some distance from the distribution panel 104. In the system 100, it is desirable to know the electrical power delivered to each of the loads at a power monitoring location 108.

Systems for monitoring the combined power delivered to all four loads are known in the art. An example is included in the system 100 of FIG. 1. The power delivered to all four loads combined is determined using a voltage tap 110 and a current tap 112. Both the current tap and the voltage tap are placed near the distribution panel 104, and the measurements are provided to the monitoring location 108. In this example, the current tap 112, the voltage tap 110, and the monitoring location 108 are within sufficient proximity that transmission delays do not affect waveform resolution between the two components. The measurement, however, does not provide sufficient information about the power delivered to the individual loads 106, which are located some distance from the distribution panel 104.

A similar arrangement may be used to monitor the power delivered to the load 106-1. A monitoring device 114 is placed on the branch feeding power to the load 106-1. The monitoring device 114 measures both current and voltage, including the waveform of each and their relationship, and the power used by the load 106-1 may be calculated at the remote monitoring point. The power used by the load 106-1 then may be transmitted to the central monitoring location 108. Because the load 106-1 is located some distance from the monitoring location 108, providing the measurement to the monitoring location 108 may require running a monitoring line 115 a considerable distance. Further, attaching the voltage monitoring device may require intrusion into the distribution branch, which may require skilled technicians and/or equipment downtime.

A different approach is used to monitor the power to the load 106-2. In this example, a monitoring device 116 unobtrusively measures the current magnitude, the current waveform, and the voltage waveform. The measurements are combined to produce an un-scaled power component. The power component is then wired to the monitoring location 108 where it is scaled using the voltage measurement from the voltage tap 110 to determine the power delivered to the load 106-2. Thus, a monitoring line 117 is run from the remote monitoring point to the central monitoring location 108.

A still different approach is used to monitor the power delivered to the load 106-3. In this embodiment, a non-intrusive current tap 118 measures the current flowing through the distribution branch to the load 106-3. The information then may be transmitted to the central monitoring location 108 using the wireless transmitter 120 where the information is combined with the voltage measurement from the voltage tap 110 to obtain the power delivered to the load 106-3. In this embodiment, it may be necessary to time stamp measurements so that the current phase may be correlated with the voltage phase. Further, the transmitter 120 may require considerable power itself to thereby transmit sufficient measurements to properly compare the current waveform to the voltage waveform to calculate power.

In another embodiment, the transmitter 120 may be bidirectional, in which case the voltage magnitude may be broadcast from the voltage to the transmitter. The power calculation then may be done at the remote monitoring point and the result transmitted to the central monitoring location 108.

In still another embodiments, a monitoring device 122 unobtrusively measures the current magnitude, the current waveform, and the voltage waveform. The measurements are combined to produce an un-scaled power component. The power component is then transmitted wirelessly to the central monitoring location 108 by the transmitter 124. Because time critical calculations are performed at the monitoring device in these embodiments, sufficient samples to properly shape the waveform need not be sent to the monitoring location. As a result, some such embodiments require very little power. Further, because intrusive connection is not required, such devices may be installed by unskilled technicians.

The transmitter 124 may be unidirectional or bidirectional, thus allowing the voltage information from the voltage tap to be received at the transmitter 124. Thus, the power used by the load 106-4 may be calculated at the monitoring device 122 and then may be transmitted to the monitoring location 108. Many such examples exist and are apparent to those skilled in the art in light of this disclosure.

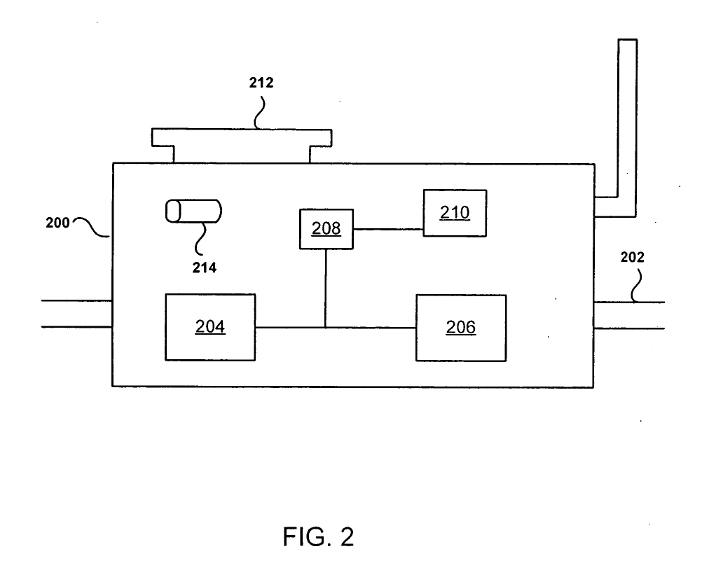

Having described embodiments of the invention deployed in an electrical power monitoring system, attention is directed to FIG. 2, which illustrates a monitoring device 200 according to embodiments of the invention. The device is most closely similar to the device 122 of FIG. 1, although with small changes, the device may be any of the monitoring devices 114, 116, 118, 122 of FIG. 1. The device 200 is attached to a transmission line supplying power to a load for which power usage is desired to be know. The device 200 includes a voltage monitoring arrangement 204 and a current monitoring arrangement 206, neither of which arrangements require invasive tapping into the transmission line 202. Thus, the device 200 may be simply clamped to the transmission line without removing power to the load.

The voltage and current information is fed to a processor 208. The processor determines a power factor by adjusting the current magnitude to account for waveform differences between the current and the voltage. Through the transmitter 210, the power factor may be transmitted to a remote monitoring location for further processing. In other embodiments, the mean absolute voltage may be received via the transmitter 210 from an external monitoring device that measures the mean absolute voltage of the transmission line 202. In such embodiments, the processor 208 then may calculate the power delivered to the load. This value then may be transmitted to an external monitoring location, for example.

The monitoring device 200 may be powered in any of a number of ways. For example, the device may include a solar cell 212 and/or battery 214. In other embodiments, the device 200 includes a parasitic power supply that uses vibration, heat, or other external energy sources to supply power to and/or generate power for the device. Thus, the device 200 may be deployed to operate wirelessly in locations where low voltage power is not available to power the device.

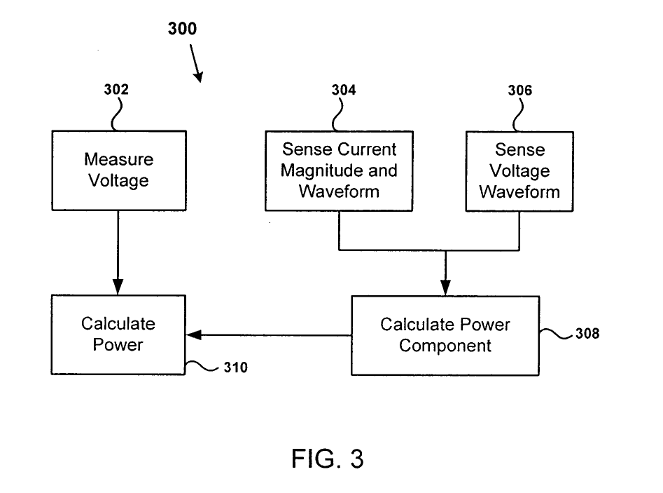

FIG. 3 illustrates an embodiment of a method 300 of measuring power delivered to a load. Those skilled in the art will appreciate that the method 300 is merely exemplary of a number of possible methods according to embodiments of the invention. Alternative methods may include more, fewer, or different steps than those illustrated and described here. The method 300 begins at block 302 at which point a voltage magnitude characteristic (e.g., RMS voltage, mean absolute voltage, or the like) is sensed. This may be accomplished by means of a voltage tap near a distribution point, such as the voltage tap 110 of FIG. 1. At block 304, which may take place in time before, after, or simultaneously with block 302, the current waveform is measured. Likewise, the voltage waveform is sensed at block 306. The current and voltage measurements may be made by a device described previously herein.

At block 308, an un-scaled power component is calculated. This may comprise adjusting the current magnitude to compensate for differences, if any, between the voltage waveform and the current waveform. The result need only be “scaled” using the voltage measurement to obtain the power delivered to the load. As previously described, the power component may be calculated at the location that the current waveform and voltage waveform are measured/sensed. Alternatively, the factors used to calculated the power component may be transmitted, either wired or wirelessly, to a different location. The different location may be the location of the voltage tap, a central monitoring location, or the like.

At block 310, the power component is “scaled” using the voltage measurement to obtain the power delivered to the load for which power is being monitored. This operation may take place at the location of the voltage tap, the location of the current monitoring device, central monitoring location, and/or the like. For example, the voltage measurement may be broadcast to a number of distributed monitoring devices deployed at various loads through an electrical distribution network. The devices may calculate the power for their individual loads and transmit the result to a monitoring location. The transmission may be via wired or wireless connection. Further, the transmission may be on a predetermined periodic schedule, upon interrogation, and/or the like. Those skilled in the art will appreciate many alternative embodiments in light of this disclosure.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. For example, those skilled in the art know how to manufacture and assemble electrical devices and components. Accordingly, the above description should not be taken as limiting the scope of the invention, which is defined in the following claims.

1. An electrical monitoring device, comprising:
an attachment arrangement adapted to attach the device, non-invasively, to an electrical supply line;
a current sensor adapted to sense waveform characteristics relating to current flowing through the supply line;
a voltage sensor adapted to sense voltage waveform characteristics of the supply line;
a processor programmed to calculate a power component using the current waveform characteristics and voltage waveform characteristics; and
a wireless transmitter configured to transmit the power component to a monitoring location.

2. The electrical monitoring device of claim 1, wherein the transmitter comprises a bidirectional transmitter configured to receive a mean absolute voltage measurement and wherein the processor is further programmed to calculate a power value using the power component and the mean absolute voltage measurement.

3. The electrical monitoring device of claim 2, wherein the transmitter is further configured to transmit the power value to a monitoring location.

4. The electrical monitoring device of claim 1, wherein the device is programmed to transmit information periodically.

5. The electrical monitoring device of claim 1, wherein the device is programmed to transmit information upon interrogation.

6. An electrical power monitoring system, comprising:
a voltage monitoring arrangement, located proximate a distribution point, configured to measure mean absolute voltage in a supply of power delivered from the distribution point to a load;
a current sensing arrangement, positioned proximate the load, configured to measure current waveform characteristics in the supply;
a non-invasive voltage monitoring arrangement, positioned proximate the current sensing arrangement, configured to measure voltage waveform characteristics in the supply;
a first processor programmed to calculate an un-scaled power component using the current waveform characteristics and voltage waveform characteristics;
a transmitter configured to transmit the un-scaled power component to a power monitoring location; and
a second processor at the power monitoring location programmed to calculate the power delivered to the load by combining the un-scaled power component with the mean absolute voltage measurement.

7. The electrical power monitoring system of claim 6, wherein the transmitter comprises a wireless transmitter.

8. The electrical power monitoring system of claim 6, wherein the voltage monitoring arrangement and the non-invasive voltage monitoring arrangement are comprised by different devices.

9. An electrical power monitoring system, comprising:
a voltage monitoring arrangement, located proximate a distribution point, configured to measure voltage magnitude in a power supply delivered from the distribution point to a load;
a current sensing arrangement, positioned proximate the load, configured to measure current magnitude and current waveform in the power supply delivered to the load;
a non-invasive voltage monitoring arrangement, positioned proximate the current sensing arrangement, configured to measure voltage waveform in the power supply;
a first processor programmed to calculate an un-scaled power component using the current waveform, voltage waveform, and current magnitude measurements;
a first transmitter configured to transmit the voltage magnitude measurement to a power monitoring location; and
a second processor at the power monitoring location programmed to calculate the power delivered to the load by combining the un-scaled power component with the voltage magnitude measurement.

10. The electrical power monitoring system of claim 9, wherein the power monitoring location comprises the location of the current sensing arrangement.

11. The electrical power monitoring system of claim 10, further comprising a second transmitter configured to transmit the power delivered to the load to a different location.

12. The electrical power monitoring system of claim 11, wherein the second transmitter comprises a wireless transmitter.

13. The electrical power monitoring system of claim 9, wherein the current sensing arrangement and the non-invasive voltage monitoring arrangement are comprised by a single monitoring device.

14. The electrical power monitoring system of claim 13, wherein the monitoring device further comprises a power supply selected from the group consisting of solar power supply, battery, and parasitic power supply.

15. A method of measuring power delivered to a load from a power supply, comprising:
sensing voltage magnitude at a first location;
sensing current magnitude, current waveform, and voltage waveform at a second location;
calculating an un-scaled power component at the first location using the current magnitude, current waveform, and voltage waveform;
transmitting either the voltage magnitude, the un-scaled power component, or both via a wireless transmission to a third location; and
calculating the power delivered to the load at the third location.

16. The method of measuring power delivered to a load of claim 15, wherein the third location and the first location comprise the same location.

17. The method of measuring power delivered to a load of claim 15, wherein the third location and the second location comprise the same location.

18. The method of measuring power delivered to a load of claim 15, wherein transmitting comprises transmitting based on a predetermined schedule.

19. The method of measuring power delivered to a load of claim 15, wherein transmitting comprises transmitting upon interrogation.

20. The method of measuring power delivered to a load of claim 15, wherein sensing current magnitude, current waveform, and voltage waveform at a second location comprises sensing current magnitude, current waveform, and voltage waveform using a non-invasive sensing device.
